(19) United States
(12) Patent Application Publication
(10) Pub. No.: US 2020/0048092 A1
(43) Pub. Date: Feb. 13, 2020

(54) PROCESS FOR RECOVERING PHOSPHOROUS FROM PHOSPHORITIC MATERIALS

(71) Applicant: COMMONWEALTH SCIENTIFIC AND INDUSTRIAL RESEARCH ORGANISATION, Acton, Australian Capital Territory (AU)

(72) Inventor: Steven WRIGHT, Acton, Australian Capital Territory (AU)

(21) Appl. No.: 16/484,520

(22) PCT Filed: Feb. 8, 2018
(86) PCT No.: PCT/AU2018/050094

§ 371 Date: Aug. 8, 2019

(30) Foreign Application Priority Data
Feb. 9, 2017 (AU) 2017900414
Aug. 22, 2017 (AU) 2017903376

(51) Int. Cl. C01B 25/18; C01B 25/01

(52) U.S. Cl. CPC C01B 25/18; C01B 25/01

(57) ABSTRACT

A process for recovering phosphorus from phosphoritic materials in a top submerged lance furnace or a fuming furnace is disclosed. The process employs a mixture of combustion agents to produce reducing conditions in the slag bath and post-combustion oxidising conditions in the headspace of the furnace. The process involves smelting a mixture of a phosphoritic material and a carbonaceous material in the furnace to produce a molten slag in the slag bath and phosphorus vapour in the headspace, wherein the post-combustion oxidising conditions in the headspace favours retention of ferrous oxides in the molten slag to minimise deportment of phosphorus to a ferro-phosphorus alloy; The phosphorus vapour in the headspace is subsequently oxidised to produce phosphorus pentoxide, which is subsequently passed from the headspace to a reactor to recover a phosphoric acid solution.

### TECHNICAL FIELD

The present disclosure relates to a process for recovering phosphorus from phosphoritic materials. In particular the present disclosure relates to a process for recovering phosphorus as phosphoric acid from phosphoritic materials.

### BACKGROUND

The following discussion of the background to the invention is intended to lacilitate an understanding of the invention. However, it should be appreciated that the discussion is not an acknowledgement or admission that any of the material referred to was published, known or part of the common general knowledge as at the priority date of the application.

Phosphorus, in the form of phosphate (PO₄³⁻), is essential for life; it is present in all living cells and is the backbone to biological molecules such as DNA and RNA, and thus is of key importance to the fertiliser industry. It cannot be manufactured and there is no substitute for it. Phosphorus is primarily sourced from the hydrometallurgical treatment of phosphorus-rich orebodies (apatites) using sulphuric acid. This wet acid process (WAP) requires a relatively high concentration of rock phosphate (>28% P₂O₅), usually achieved through beneficiation. It involves the reaction of 93% sulphuric acid an tricalcium phosphate as described below:

Ca₅(PO₄)₃X+5H₂SO₄+10H₂O→3H₃PO₄+5CaSO₄.2H₂O+HX (1)

where X=OH, F, Br, Cl.

Typically large scale operations use this WAP process with high grade ore, and produce high grade phosphoric acid and 5 tonnes of waste product for every tonne of H₃PO₄. There is approximately 1 Bt of waste product stockpiled worldwide.

There are many medium to low grade phosphate ore deposits in Australia and around the globe that have potential for development but for which the Wet Acid Process (WAP) is not particularly suitable. Many of these provide technical challenges for upgrading to produce a high-grade phosphate concentrate. Some ores are a mixture of apatites, crandilites, monazite, clays and quartz and many minor phases. While they may also contain other elements of value such as rare earths, they are extremely difficult to recover. The mineral grain size of the ore is very small and upgrading the ore to a concentrate has proven difficult. The economics of the projects would improve substantially if the phosphorus could be extracted in a high purity stream.

Pyrometallurgy provides an alternative option to phosphate processing, whereby phosphorus containing ores are smelted to produce a phosphorus rich gas phase, where the P can be recovered as an element (P₂) or as an oxide (P₂O₅) to make phosphoric acid. The conventional industrial process is to smelt phosphorus ore with coke and a quartz flux in an electric arc furnace or a rotary kiln, and historically in a blast furnace.

However, there are several operational limitations associated with using an electric arc furnace or a rotary kiln including: batch mode processing and the inability to operate continuously; pre-treatment of feed materials including crushing and pelletising of phosphoritic material, flux and reductant; dust formation; intentional avoidance of forming molten liquids in rotary kilns, thereby leading to slow rates of reaction because of inadequate mixing; reductant is constrained to coke; short circuiting of feed materials without reaction; and poor thermal energy conservation.

In smelting methods where phosphorus is produced in a molten slag, any iron in the ore combines with the phosphorus to produce a ferro-phosphorus alloy leading to P losses of up to 17-20%. Although the ferro-phosphorus alloy can be recycled or further processed, additional energy is required to recover the phosphorus from the ferro-phosphorus alloy.

Thus, there is a need to develop alternative and more efficient processes for recovery of phosphorus from phosphoritic materials.

### SUMMARY

The present disclosure provides a process for recovering phosphorus from phosphoritic materials.

In one aspect of the disclosure there is provided a process for recovering phosphorus from phosphoritic materials. The process comprises:

providing a furnace comprising a slag bath and a headspace above the slag bath, wherein the furnace is configured to facilitate submerged injection of a fluid into the slag bath, the fluid comprising a mixture of combustion agents to produce reducing conditions in the slag bath and post-combustion oxidising conditions in the headspace;

smelting a mixture of a phosphoritic material and a carbonaceous material in the furnace to produce a molten slag in the slag bath and phosphorus vapour in the headspace, wherein the post-combustion oxidising conditions in the headspace favour retention of ferrous oxides in the molten slag to minimise deportment of phosphorus to a ferro-phosphorus alloy;

oxidising the phosphorus vapour in the headspace to produce phosphorus pentoxide; and,

passing the phosphorus pentoxide from the headspace to a reactor to recover a phosphoric acid solution.

The furnace may be any furnace with submerged or submergible tuyeres. In one embodiment the furnace may be a top submerged lance furnace. In another embodiment, the furnace may be a fuming furnace.

The fluid may be injected into the molten slag at a flow velocity of from 30 to 70 m/s at standard temperature and pressure. In some embodiments, the flow velocity of the fluid is sufficient to eject molten slag droplets into the headspace of the furnace. Advantageously, the molten slag droplets in the headspace may be heated by oxidative conversion of phosphorus vapour to phosphorus pentoxide, thereby heating the molten slag when the molten slag droplets fall into the molten slag under the influence of gravity.

Additionally, the molten slag droplets may be oxidised in the headspace, thereby favouring retention of ferrous oxides in the molten slag to minimise deportment of phosphorus to a ferro-phosphorus alloy.

In one embodiment, the mixture of phosphoritic material and carbonaceous material may further comprise a flux. The flux may be present in the mixture in an amount to obtain and maintain the molten slag at a liquidus temperature of 1400° C. or less.

In one embodiment the flux may be present in the mixture to provide Al₂O₃ n a range of 10 to 20% in the molten slag and a CaO:SiO₂ ratio between 1 and 0.25 in the molten slag.

In one embodiment, the smelting step may comprise:

a) feeding the phosphoritic material to the furnace to produce a molten slag having a high P content and,

b) reducing the P content in said molten slag to produce phosphorus vapour in the headspace of the furnace.

In some embodiments, step b) comprises ceasing step a) and adding the carbonaceous material to the furnace under operating conditions suitable for reducing the P content in said molten slag to <1%.

In one embodiment, smelting said mixture comprises maintaining the molten slag at a temperature of about 100° C. above a liquidus thereof, in particular in a range of from 1300° C. to 1500° C., even more particularly in a range of from 1340° C. to 1450° C.

In one embodiment, maintaining the molten slag at about 100° C. above the liquidus thereof comprises heating and agitating the molten slag by injecting said fluid therein.

The combustion agents may comprise an oxygen-containing gas and a combustible fuel. The combustible fuel may be a hydrocarbon gas, such as natural gas. Alternatively, the combustible fuel may be the carbonaceous material, as previously described. In one embodiment, the carbonaceous material has a particle size less than 0.5 mm. In particular, the carbonaceous material has a particle size P₈₅<75 μm.

In one embodiment, oxidising the phosphorus vapour comprises providing an oxygen-containing gas in the headspace of said furnace to react with the phosphorus vapour therein.

In one embodiment, prior to passing the phosphorus pentoxide to the reactor, the process further comprises recovering thermal energy from the phosphorus pentoxide. The recovered thermal energy may be utilised for drying and/or heating feed materials for said furnace, power generation, and/or heating fluid streams.

In one embodiment, the molten slag comprises less than 5 wt % ferro-phosphorus alloy. In one particular embodiment the molten slag comprises 1 wt % or less phosphorus. The ferro-phosphorus alloy may further comprise one or more metals other than iron. It will be appreciated that the ferro-phosphorus alloy may be dispersed in the molten slag.

The process may further comprise the step of tapping the molten slag from said furnace. The tapped slag may undergo further processing to separate and recover the ferro-phosphorus alloy therein. Phosphorus recovered from the slag or ferro-phosphorus alloy may be recycled into the furnace. The slag may be utilised for cement making or as a material for road base.

### BRIEF DESCRIPTION OF DRAWINGS

Preferred embodiments of the present invention will now be further described and illustrated, by way of example only, with reference to the accompanying drawings in which:

FIG. 1 is a schematic representation of a top submerged lance (TSL) furnace for performing one embodiment of a process for recovering phosphorus from phosphoritic materials as described herein;

FIG. 2 is a schematic representation of a fuming furnace for performing one embodiment of a process for recovering phosphorus from phosphoritic materials as described herein;

FIG. 3 is graphical representation of the change in P₂O₅ content with time for experiment PHOSB described in the Example section of the description, where the medium grade concentrate was smelted at 1500° C. with graphite; and,

FIG. 4 is a graphical representation of the change in the reduction rate of P from the slag at 1500° C. as a function of slag basicity as described in the Example section of the description.

### DESCRIPTION OF EMBODIMENTS

The disclosure relates to a process for recovering phosphorus from phosphoritic materials. In particular the disclosure relates to a process for recovering phosphorus as phosphoric acid from phosphoritic materials.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

### Specific Terms

The term ‘phosphoritic material’ as used herein refers to any phosphate-containing substance. The term may be used predominantly to refer to sedimentary rock containing phosphate minerals, in particular apatite. Apatite may generically refer to a group of isomorphous hexagonal phosphate minerals. The primary apatite group includes fluorapatite (Ca₅(PO₄)₃F), chlorapatite (Ca₅(PO₄)₃Cl), and hydroxylapatite (Ca₅(PO₄)₃OH), while the extended apatite supergroup may include additional minerals such as pyromorphite, mimetite, and vanadinite. Several base metals may also be associated with these phosphate minerals including, but not limited to, Fe, Zn, Cu, Pb. Accordingly, the term ‘phosphoritic material’ encompasses high grade phosphate ores and concentrates as well as medium to low grade ores, concentrates and blends thereof.

Notwithstanding the preceding paragraph, a phosphoritic material, as defined herein, may comprise phosphate-containing waste materials, including, but not limited to, municipal sewage waste (MSW), ash generated from incineration of MSW, phosphorus sludges and residues from contact phosphoric acid production.

It will be appreciated by those skilled in the art that the phosphoritic material may additionally comprise other minerals and materials commonly associated with phosphates including, but not limited to, silicates, aluminates, aluminosilicates, and other metal oxides. Illustrative examples of other metal oxides include iron oxide and rare earth metal oxides.

The term ‘carbonaceous material’ as used herein is defined in the broadest terms and includes any carbon-containing material capable of combining with oxygen to form carbon monoxide, thereby reducing the phosphoritic material to elemental phosphorus. The ‘carbonaceous material’ may be selected from a group comprising coal, coal-based products, coke, char, charcoal, activated carbon, wood, wood chips, sawdust, biomass, tars, heavy oils, biofuels such as biodiesel, waste rubber including but not limited to vehicle tyres, waste plastic materials, contaminated soils, mixtures thereof and mixtures of said carbonaceous materials with other substances.

The expression ‘post-combustion oxidising conditions’ as used herein refers to an oxygen-rich atmosphere wherein one or more combustible compounds have been completely converted to one or more compounds corresponding to the final oxidation state of the one or more combustible compounds. For example, carbon monoxide may be converted to carbon dioxide, hydrogen to water, hydrocarbons to carbon dioxide, and so forth.

### Process for Recovering Phosphorus

The process for recovering phosphorus from phosphoritic materials may comprise the steps of:

providing a furnace comprising a slag bath and a headspace above the slag bath, wherein the furnace is configured to facilitate submerged injection of a fluid into the slag bath, the fluid comprising a mixture of combustion agents to produce reducing conditions in the slag bath and post-combustion oxidising conditions in the headspace;

smelting a mixture of a phosphoritic material and a carbonaceous material in the furnace to produce a molten slag in the slag bath and phosphorus vapour in the headspace, wherein the post-combustion oxidising conditions in the headspace favours retention of ferrous oxides in the molten slag to minimise deportment of phosphorus to a ferro-phosphorus alloy;

oxidising the phosphorus vapour in the headspace to produce phosphorus pentoxide; and,

passing the phosphorus pentoxide from the headspace to a reactor to recover a phosphoric acid solution.

The phosphoritic material may undergo no or minimal pre-treatment unless the phosphoritic material has a significant Fe content, in which case the phosphoritic material may undergo a suitable pre-treatment process to reduce the Fe content to less than 2-3%. Fe content is particularly detrimental to recovery of phosphorus as phosphoric acid because iron may form a ferro-phosphorus alloy under the reducing conditions in the slag bath. Under equilibrium conditions reduced phosphorus tends to report to the ferro-phosphorus alloy rather than the headspace of the furnace, leading to increased phosphorus losses.

As most phosphoritic materials are impure, it may be necessary to add a flux to remove accompanying metal oxides as slag, reduce the liquidus temperature and viscosity of the slag and render the slag more fluid at smelting temperatures. Accordingly, in one embodiment, the mixture of phosphoritic materials and carbonaceous material further comprises a flux.

The flux may be present in the mixture to obtain and maintain a molten slag at a temperature of 1500° C. or less. The flux may be one or more compounds selected from a group comprising Al₂O₃, CaO, MgO, and SiO₂. In one embodiment, the flux may be present in the mixture in an amount to obtain and maintain the molten slag at a liquidus temperature of 1400° C. or less. The flux may be present in the mixture to provide Al₂O₃ in a range of 10 to 20% in the molten slag and a CaO:SiO₂ ratio between 1 and 0.25 in the molten slag.

It will be appreciated that the amount of flux included in the mixture, and the composition of the flux, will vary and depend on the composition of the phosphoritic material, the amount of one or more of Al₂O₃, CaO, MgO, and SiO₂ in the phosphoritic material, and the respective ratios of CaO/SiO₂, CaO/Al₂O₃, and SiO₂/Al₂O₃ in the phosphoritic material. In some embodiments where a plurality of phosphoritic materials may be blended together, wherein the phosphoritic materials have one or more minerals or metal oxides such as SiO₂, Al₂O₃. CaO. MgO associated therewith, the mixture of phosphoritic material and carbonaceous material may be sell-fluxing (i.e. capable of producing a molten slag with a liquidus temperature at 1400° C. or less without the need for an additional flux).

Advantageously, the phosphoritic material, carbonaceous material and, optionally, the flux do not need to undergo comminution to a specific particle size range prior to smelting. The phosphoritic material, carbonaceous material and the flux may be fed as lump into the furnace, whereas rotary kilns used in prior art processes require crushing and pelletising of the feed materials. Consequently, there is little or no dust formation in comparison to rotary kiln processes.

The furnace may be any suitable smelting furnace configured to hold and maintain a molten slag at a temperature above its liquidus, wherein the furnace is configured to facilitate submerged injection of a fluid into the molten slag. The term ‘liquidus’ as used herein refers to the temperature above which the slag is completely liquid, and the maximum temperature at which crystals can co-exist with the molten slag in thermodynamic equilibrium.

Illustrative examples of suitable smelting furnaces for performing the process as described herein include a top submerged lance furnace or a fuming furnace.

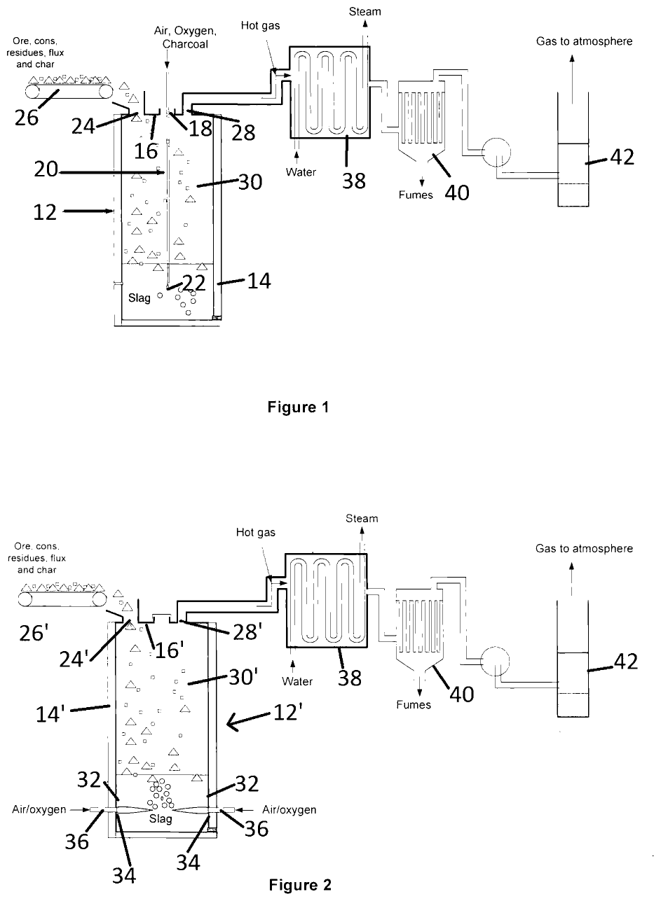

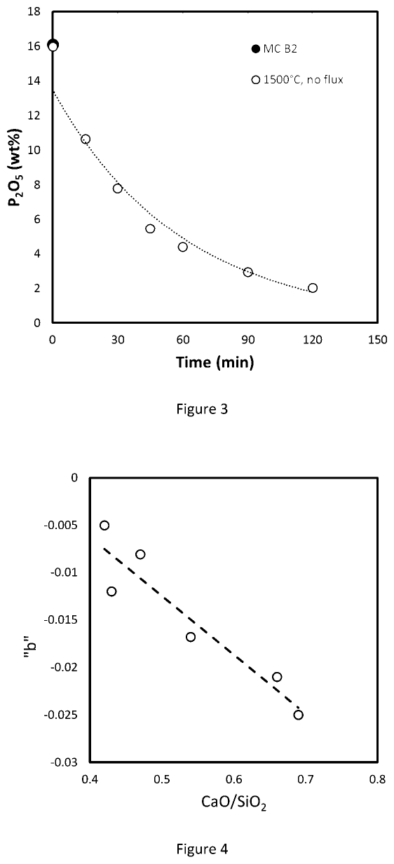

Referring to FIG. 1 there is shown a top submerged lance furnace 12 configured to perform the process as described herein. Said furnace 12 includes a liquid pyrometallurgical bath comprising the molten slag or having the molten slag on its surface. The liquid pyrometallurgical bath may take the form of a generally vertical cylindrical vessel 14. A top wall 16 of the vessel 14 may have an opening 18 to receive a lance 20 having a free end 22 submerged below the molten slag. The lance 20 is arranged to inject a fluid comprising a mixture of combustion agents into the molten slag. The opening 18 is generally centrally disposed in the top wall 16 so that injection of the fluid into the molten slag provides efficient mixing and heat transfer.

The top wall 16 of the vessel 14 may have input port 24 to receive the mixture of the phosphoritic material, the carbonaceous material and, optionally, the flux into the furnace 12. The mixture may be delivered to the opening 24 by a belt feeder 26 or any suitable conveyor.

The top wall 16 of the vessel 14 may have an output port 28 for discharging phosphorus pentoxide and exhaust gas from a headspace 30 of the furnace 12.

Referring to FIG. 2, where like reference numerals are used to refer to like parts, there is shown a fuming furnace 12′ configured to perform the process as described herein. Said furnace 12′ includes a liquid pyrometallurgical bath comprising the molten slag or having the molten slag on its surface. The liquid pyrometallurgical bath may take the form of a generally vertical cylindrical vessel 14′.

A side wall 32 of the vessel 14′ may have one or more openings 34 to receive respective injection nozzle(s) 36 submerged below the molten slag. The injection nozzle(s) 36 is/are arranged to inject a fluid comprising a mixture of combustion agents into the molten slag. The one or more openings 34 is/are generally equidistantly disposed in a lower portion 36 of the side wall 32 so that injection of the fluid into the molten slag provides efficient mixing and heat transfer.

A top wall 16′ of the vessel 14′ may have input port 24′ to receive the mixture of the phosphoritic material, the carbonaceous material and, optionally, the flux into the furnace 12′. The mixture may be delivered to the opening 24′ by a belt feeder 26′ or any suitable conveyor.

The top wall 16′ of the vessel 14′ may have an output port 28′ for discharging phosphorus pentoxide and exhaust gas from a headspace 30′ of the furnace 12′.

### Smelting the Mixture

The process of recovering phosphorus from phosphoritic materials comprises the step of smelting a mixture of a phosphoritic material, a carbonaceous material and, optionally, a flux in a furnace to produce a molten slag in the slag bath and phosphorus vapour in the headspace of the furnace.

The smelting step may be performed at a temperature above a liquidus of the molten slag. In one embodiment, the smelting step may be performed at a temperature of about 100° C. above the liquidus of the molten slag.

Generally, the smelting step may be performed at a temperature in a range from 1300° C. to 1500° C., even more particularly in a range of from 1340° C. to 1450° C.

Maintaining the molten slag at a temperature above the liquidus thereof comprises heating and agitating the molten slag by injecting a fluid comprising a mixture of combustion agents therein.

The term ‘combustion agents’ as used herein refers to any chemical substance capable of combining and reacting to produce sufficient heat to maintain the molten slag at a temperature above the liquidus thereof. The combustion agents may comprise an oxygen-containing gas and a combustible fuel.

Illustrative examples of the oxygen-containing gas include air and pure oxygen.

The combustible fuel may be a hydrocarbon gas, such as natural gas, or a hydrocarbon liquid, such as heavy oils, kerosene or biofuels such as biodiesel. Alternatively, the combustible fuel may be the carbonaceous material as described previously. It will be appreciated that, in some embodiments, the carbonaceous material may have a dual purpose as a reducing agent for reduction of phosphoritic materials to elemental phosphorus and as a combustible fuel for combination with the oxygen-containing gas to produce heat.

When used as a combustible fuel, the carbonaceous material may have a particle size less than 0.5 mm. In certain embodiments, the carbonaceous material may have particle sizes less than 300 micron, 250 micron, 150 micron or even 100 micron. In one particular embodiment, the carbonaceous material may be sized with 85% thereof passing 75 micron.

The mixture may be a homogenous mixture of gaseous combustion agents or a heterogeneous fluidised mixture of gaseous and solid combustion agents. For example, the fluid may be a suspension of carbonaceous material in air. Alternatively, the fluid may be a slurry.

The fluid comprising the combustion agents may be injected into the molten slag at a flow velocity of from 30 to 70 m/s at standard temperature and pressure. In some embodiments, the flow velocity of the fluid is sufficient to eject molten slag droplets into the headspace of the furnace. Advantageously, the molten slag droplets in the headspace are heated by oxidative conversion of phosphorus vapour to phosphorus pentoxide, thereby heating the molten slag when the molten slag droplets fall into the molten slag under the influence of gravity.

Air or other oxygen-containing gas may be introduced into the headspace to maintain post-combustion oxidising conditions therein. When molten slag droplets are ejected into the headspace of the furnace, the difference between the post-combustion oxidising conditions and the reducing conditions in the slag bath creates a disequilibrium in the molten slag, favouring retention of iron oxides (and other metal oxides) in the molten slag. This is achieved, in part, by oxidation of the slag droplets when they are ejected into the headspace of the furnace. Retention of iron oxides in the molten slag decreases the formation of ferro-phosphorus alloy in the molten slag, thereby decreasing the amount of phosphorus deporting to the ferro-phosphorus alloy in the molten slag and increasing the amount of elemental phosphorus vapour reporting to the headspace of the furnace.

In the smelting step the phosphoritic material is reacted with the carbonaceous material to reduce phosphate to elemental phosphorus which reports to the headspace of the furnace as phosphorus vapour. Carbon in the carbonaceous material oxidizes to form carbon monoxide which then mixes with the other gases volatilized from the furnace, such as hydrogen from any hydrocarbons present in the carbonaceous material, nitrogen and unreacted oxygen-containing gas. These gases report to the headspace of the furnace.

Most of the carbon monoxide is derived from the reduction of combined phosphorus in phosphate ore and only a small proportion is formed by the reduction of metal oxides.

In some embodiments, the smelting step may involve first feeding the phosphoritic material to the furnace to produce a molten slag having a high P content. It will be appreciated that the fluid comprising the combustion agents is injected into the furnace at the same time as phosphoritic material is fed to the furnace, in order to produce sufficient heat in the furnace to maintain the resulting molten slag at a temperature above its liquidus. Under these conditions, there is little or no production of phosphorus vapour (i.e. P fuming) and the P content of the molten slag is relatively high.

After feeding the phosphoritic material to the furnace has ceased, carbonaceous material may be added to the furnace to reduce the P content in said molten slag thereby producing phosphorus vapour in the headspace of the furnace and carbon monoxide. The operating conditions of the furnace, such as for example, the operating temperature and the relative proportions of combustible fuel and oxygen in the combustible agents, may be selected to reduce the P content in the molten slag to <1%.

The inventors opine that in the latter embodiment, it may be more efficient to delay the addition of the carbonaceous material to the furnace until said molten slag is at a temperature above its liquidus. In this way, consumption of carbonaceous material in an oxidising environment to attain a molten slag at a temperature above its liquidus is minimised—in the second step the carbonaceous material may be more efficiently used as a reductant for production of phosphorus vapour.

If the slag bath is operated under highly reducing conditions, some of the metal oxides present in the phosphoritic material may be reduced to metallic elements. The one or more metallic elements may alloy with any ferro-phosphorus alloy which forms in the molten bath. In particular, iron oxide may be reduced to elemental iron which combines with elemental phosphorus to produce a ferro-phosphorus alloy containing 23-30 wt % P.

The inventor has found that production of phosphorus vapour is reduced as slag volume increases or if the Fe content in the phosphoritic material increases. The lower the iron content in the feed, the lower the phosphorus losses unless the ferro-phosphorus alloy is processed to recover the phosphorus.

Several of the metal oxides present in the phosphoritic material may not be reduced to metallic elements by the carbonaceous material and these combine to form the molten slag. It will be appreciated that the ferro-phosphorus alloy is also molten under the operating temperatures of the furnace and combines with the molten slag as a mixture of two liquid phases.

Advantageously, the inventor has found that the post-combustion oxidising conditions in the headspace may be arranged to favour formation of ferrous oxides in the molten slag rather than reduction of iron oxides to elemental iron and subsequent formation of the ferro-phosphorus alloy. In this way, phosphorus recovery as phosphoric acid is increased because phosphorus reduced in the molten bath reports to the headspace as elemental phosphorus vapour rather than reporting to the ferro-phosphorus alloy.

In one embodiment, wherein the Fe content of the molten slag is low, the post-combustion oxidising conditions and the fluid injection rate are arranged to return heat to the slag bath and produce a molten slag having a low iron oxide content and a small volume of ferro-phosphorus alloy (<1% vol).

In another embodiment, wherein the Fe content of the molten slag is high, the post-combustion oxidising conditions and the fluid injection rate are arranged to favour dis-equilibrium between the molten slag and the ferro-phosphorus alloy to retain iron oxides in the slag and minimise ferro-phosphorus production. In this particular embodiment, the molten slag may have a P content >1%, but the overall deportment of phosphorus to the slag and the ferro-phosphorus alloy will be much lower than would be anticipated under equilibrium conditions whereby all the iron oxide in the molten slag would be reduced to form ferro-phosphorus alloy.

Under equilibrium conditions, if the Fe content in the molten slag is greater than 2 wt %, the amount of ferrophosphorus alloy produced in the molten slag would be about 3%, resulting in overall recovery of P as phosphorus vapour of less than 90%. At high Fe levels under equilibrium conditions, overall recovery of P as phosphorus vapour to the headspace of the furnace is low and it will be appreciated that the ferrophosphorus alloy would require further processing to recover the P.

The detrimental effect of Fe content in the mixture on P recovery may be illustrated by the following table which is modelled on 1 ton ore containing 20% P₂O₅, (8.7% P, 87 kg input). When fluxed, the 1 ton of ore yields 1 ton slag with a final slag containing 1% P₂O₅(0.43% P).

TABLE

| Fe in | | FeP alloy | P in FeP | P in gas | P recovery |
|---|---|---|---|---|---|
| ore (%) | P in slag | (kg) | alloy (kg) | (kg) | to gas (%) |
| 0 | 4.3 | 0 | 0 | 82.18 | 95 |
| 1 | 4.3 | 13.3 | 3.3 | 78.90 | 91 |
| 2 | 4.3 | 26.6 | 6.6 | 75.60 | 87 |
| 5 | 4.3 | 66.5 | 16.5 | 65.70 | 76 |
| 10 | 4.3 | 133 | 33.0 | 49.0 | 56 |

The process may further comprise the step of tapping the molten slag from the furnace. The term ‘tapping’, ‘tapped’ or any of its variants as used herein refers to a process where the molten slag is drawn from the furnace, typically by removal of a plug from an opening or a taphole, at the base of the furnace. The molten slag flows through a clay-lined runner and may be transferred by launder to a holding furnace, where the two liquid phases will be kept in the furnace for sufficient time to separate and to be separately tapped. Tapping the molten slag from the furnace may be performed continuously or intermittently.

The tapped slag may undergo further processing to recover one or more metals from the ferro-phosphorus alloy therein. For example, the slag may be slowly cooled to encourage crystallisation of primary and secondary phases from the slag which encourages the segregation and formation of a phosphorus rich oxide phase from a silicate glass phase. By allowing the crystals to grow sufficiently large, it may be possible to either liberate the phosphorus rich oxide phase from the slag alter crushing, or make them amenable to leaching without dissolving the silicate glass phase. Valuable elements, such as rare earths may also deport to the phosphorus rich oxide phase and could also be recovered. Similarly, the formation of a Fe—P alloy may also act as a collector for other elements, which could be recovered by separately processing the alloy.

Phosphorus recovered from the slag or ferrophosphorus alloy may be recycled into the furnace.

The separated slag may be low in phosphorus, non-toxic and may have similar properties to iron-blast furnace slags. Consequently, the separated slag may be utilised for cement making or as a material for road base, in a similar manner as iron blast furnace slag.

In one embodiment, the slag comprises <1 wt % P, with the balance of total P reporting as phosphorus vapour to the headspace of the furnace. Depending upon the concentration of P in the phosphoritic material, the overall recovery of P as phosphorus vapour may be greater than 90% for low Fe content in the mixture of phosphoritic material, carbonaceous material and, optionally, the flux.

### Oxidising the Phosphorus Vapour

The process for recovering phosphorus from phosphoritic materials also comprises the step of oxidising the phosphorus vapour in the headspace of the furnace to produce phosphorus pentoxide. Generally, the phosphorus vapour reacts with an oxygen-containing gas in the headspace to produce phosphorus pentoxide.

The post-combustion oxidising conditions in the headspace of the furnace are arranged for complete oxidation of carbon monoxide, hydrogen and elemental phosphorus vapour.

In some embodiments, the post-combustion oxidising conditions in the headspace are in disequilibrium with the reducing conditions in the molten bath, thereby resulting in a greater concentration of molten metal oxides, including ferrous oxides, in the molten slag than would be expected under equilibrium conditions. Advantageously, this reduces the amount of elemental iron in the molten slag which in turn reduces the amount of elemental phosphorus which reacts with elemental iron to produce a ferro-phosphorus alloy. In this way, more phosphorus reports to the headspace of the furnace as elemental phosphorus vapour.

The oxygen-containing gas may comprise unreacted oxygen-containing gas which has been injected into the molten slag and has reported to the headspace. The phosphorus pentoxide may be present in the headspace as a gas or as a gas-borne particulate.

The oxidative reaction between the phosphorus vapour and the oxygen-containing gas in the headspace of the furnace is exothermic and produces heat. Advantageously, any droplets of molten slag which are ejected from the molten slag into the headspace are healed in the headspace of the furnace. When the droplets fall under the influence of gravity into the molten slag, they effectively increase the heat transfer from the heated gases in the headspace of the furnace to the molten slag.

It will also be appreciated that the mixture of phosphoritic material, carbonaceous material and, optionally, the flux will also be pre-heated by the gases in the headspace of the furnace as it descends into the furnace.

### Recovering a Phosphoric Acid Solution

The process for recovering phosphorus from phosphoritic materials also comprises the step of passing the phosphorus pentoxide from the headspace to a reactor to recover a phosphoric acid solution.

The reactor may be any reactor configured to produce a phosphoric acid solution. One example of a suitable reactor includes, but is not limited to, a scrubber, such as a wet scrubber. The reactor may be configured to bring the phosphorus pentoxide into contact with an aqueous liquid, by spraying it with said liquid, by forcing it through a volume of said liquid, or by some other contact method, so as to convert phosphorus pentoxide into phosphoric acid.

The phosphorus pentoxide gas or gas-borne phosphorus pentoxide particulate may be drawn from the headspace of the furnace through an output port and directed to the reactor where it is passed through an aqueous solution to produce a phosphoric acid solution. The phosphorus pentoxide gas or gas-borne phosphorus pentoxide may be drawn from the headspace under negative or positive pressure.

As discussed above, the gas mixture produced in the headspace is heated by the exothermic oxidative reaction between the phosphorus vapour and the oxygen-containing gas. In some embodiments it may be useful to recover the heat from the gas mixture. Accordingly, prior to passing the phosphorus pentoxide to the reactor, the process may further comprise recovering thermal energy from the phosphorus pentoxide. The recovered thermal energy may be utilised for drying and/or heating feed materials for said furnace, power generation, and/or heating fluid streams including the fluid comprising the mixture of combustion agents as described previously.

Referring to FIGS. 1 and 2, a heated gas mixture containing phosphorus pentoxide may be drawn from the output port 28 and passed through a boiler 38 to produce steam. The steam may be utilised to generate electrical power which may be used throughout the plant. Alternatively, the steam may be utilised to dry and/or heat one or more feed materials or fluid streams.

The cooled gas mixture may then be filtered, such as by passing through a baghouse 40, to remove unwanted particulates by filtration before passing the cooled gas mixture to a scrubber 42. The phosphorus pentoxide in the cooled gas mixture reacts with water in the scrubber 42 to produce a phosphoric acid solution.

For one skilled in the art, the advantages of the process as described herein in comparison to existing high temperature processes for the production of phosphoric acid will become apparent and include:
Fewer processing steps compared to existing processes for recovery of phosphorus from phosphoritic materials
The phosphoritic material and carbonaceous material requires minimal preparation and can be fed as lump into the furnace, whereas rotary kilns require crushing and pelletising of the feed materials.
A completely liquid slag is formed. Liquid formation is avoided or minimised in rotary kiln processes.
There is minimal short circuiting of feed without reaction, which can occur with a rotary kiln process. The term ‘short circuiting’ refers to material which enters and exits the furnace without participating in the reaction.
Little or no dust formation in comparison to rotary kiln processes.
There are higher rates of reaction at the same temperature due to greater mixing of reactants in the slag from gas agitation compared to blast furnaces and electric furnaces. The process can operate at a lower temperature than an electric furnace, thereby saving energy, and it can operate at a higher temperature than with a rotary kiln, thereby operating with higher reaction rates.
A broad range of carbonaceous materials, such as coal, charcoal or biomass can be used as the reductant. Blast furnace and electric furnace processes, on the other hand, are restricted to using coke.
Heat can be returned to the pyrometallurgical bath from slag splash. Slag droplets ejected from the bath are superheated by oxidation of the phosphorus vapours and carbon monoxide produced from the reduction reactions. This heat is returned to the bath when the droplets fall under the influence of gravity.
The feed can be preheated by the superheated gases as it descends into the bath.
Natural gas can be used as a fuel in lance or injection nozzles.
The process can be operated as a batch or continuous smelting process.

The main advantages of the process described herein over the existing wet acid process (WAP) are that lower grade ores can be processed with less mineral processing required and less waste is produced. For example, no gypsum by-product is produced by the present process, whereas approximately 5 tonnes of waste per ton of phosphorus is produced in most WAP.

### Example

The invention is further illustrated by the following example. The example is provided for illustrative purposes only. It is not to be construed as limiting the scope or content of the invention in any way.

Three samples of ore or concentrate were tested to show that low phosphorus contents in the slag and high phosphorus recoveries to the gas can be achieved at the smelting temperatures in a range of 1350° C.-1500° C.

The composition of three samples are given in Table 1, designated Batch 2 Medium grade concentrate (MC B2), Batch 2 Low grade concentrate (LC B2) and High grade ore (HO). The composition of the major and minor components of these materials are given in Table 2 and Table 3 respectively. Laboratory reagent grade alumina and silica supplied as powders were used to flux the phosphorus materials for the test work.

TABLE 1
Composition of the phosphorite samples

| | Al₂O₃ | CaO | Fe₂O₃ | K₂O | MgO | P₂O₅ | SiO₂ | TiO₂ |
|---|---|---|---|---|---|---|---|---|
| | (wt | (wt | (wt | (wt | (wt | (wt | (wt | (wt |
| | %) | %) | %) | %) | %) | %) | %) | %) |
| MC B2 | 5.84 | 22.0 | 2.07 | 0.77 | 0.65 | 16.106 | 45.2 | 0.33 |
| LC B2 | 7.4 | 19.1 | 6.3 | 0.7 | 0.71 | 13.90 | 43.3 | 0.25 |
| HO | 3.70 | 28.60 | 1.54 | 0.70 | 0.39 | 20.95 | 38.36 | 0.20 |

The amount of flux per ton of ore for the phosphorus materials to be tested in this study is given below.

TABLE 2
Feed requirements, (ore, flux and reductant)
and smelting temperature.

| | P₂O₅ | Flux | Flux | C | N₂ | Temp |
|---|---|---|---|---|---|---|
| | (wt %) | (type) | (t) | (t) | (Nm³) | (° C.) |
| High (Ave) | 21.19 | SiO₂ | 0.12 | 0.09 | 800 | 1390 |
| LG Batch 2 | 18.16 | Al₂O₃ | 0.07 | 0.095 | 650 | 1400 |
| MG Batch 2 | 19.91 | Al₂O₃ | 0.07 | 0.086 | 700 | 1400 |

The samples were smelted at kilogram scale to simulate the smelting reactions in a large scale TSL furnace. The aim of the tests was to gain an appreciation of the relative rates of P₂O₅ reduction from slag achieved by fluxing phosphate concentrate and ore under reducing conditions and the likely phosphorus recovery. The program of tests are given in Table 3. The program of work was not designed to be a systematic study, but one where the potential to recover the phosphorus was examined.

TABLE 3
Tests carried out to evaluate smelting
behaviour of phosphoritic samples.

| | | Mass | | Mass | Temp | N₂ |
|---|---|---|---|---|---|---|
| | | (g) | Flux | (g) | (° C.) | (l/min) |
| PHOS2 | MC B2 | 450 | Al₂O₃ | 63 | 1400 | 4 |
| PHOS3 | HO | 450 | SiO₂ | 31.5 | 1500 | 4 |
| PHOS4 | HO | 450 | SiO₂ | 31.5 | 1500 | 4 |
| PHOS5 | LC B2 | 450 | | | 1500 | 4 |
| PHOS6 | LC B2 | 450 | Al₂O₃ | 67 | 1500 | 4 |
| PHOS7 | MC B2 | 450 | Al₂O₃ | 63 | 1500 | 4 |
| PHOS8 | MC B2 | 450 | | | 1500 | 4 |

The mass balance for each test is given in Table 4. The total mass of slag collected is the weight of the final cold slag in the crucible plus the mass of the slag dip samples collected during the tests. The average CaO/SiO₂ ratio and alumina content of the slags are also given, as well as the P₂O₅ content at the first and final dip of the experiment. The amount of P retained in the slag was calculated using two independent methods; from the mass balance and from the change in the P₂O₅/CaO ratio in the slag compared to the input ratio in the concentrate/ore. In some tests, metal formed as coalesced droplets and was separated from the slag in tests 4 through to 8, and contained around 24% P and 0.08% C.

TABLE 4
Mass balance, phosphorus inputs, outputs and recovery.

| | Slag | Dips* | Total^{$} | | Al₂O₃ | Pₜ₌₀ | P_{t=f} | P_{Input} | P_{Final} | P_{Slag}^{#} | P_{Slag}^{‡} | Metal | P | P_{Metal} | P_{Gas} |
|---|---|---|---|---|---|---|---|---|---|---|---|---|---|---|---|
| | (g) | (g) | (g) | CaO/SiO₂ | (wt %) | (wt %) | (wt %) | (g) | (g) | (%) | (%) | (g) | (wt %) | (%) | (%) |
| PHOS2 | 406 | 30.4 | 436.4 | 0.47 | 18.84 | 6.16 | 5.78 | 31.64 | 25.22 | 79.7 | 91.3 | | | | 20.3 |
| PHOS3 | 328 | 36.5 | 364.5 | 0.66 | 6.85 | 3.84 | 1 | 41.15 | 3.65 | 8.9 | 9.3 | | | | 91.1 |
| PHOS4 | 328 | 36.5 | 364.5 | 0.69 | 7.70 | 8.37 | 0.18 | 37.68 | 0.66 | 1.8 | 1.6 | 2.3 | 23.2 | 1.4 | 96.8 |
| PHOS5 | 311 | 42 | 353 | 0.42 | 10.93 | 4.67 | 1.86 | 27.31 | 6.57 | 24.1 | 24.3 | 17 | 24.4 | 15.2 | 60.7 |
| PHOS6 | 343 | 53 | 396 | 0.43 | 22.40 | 4.17 | 1.2 | 27.31 | 4.75 | 17.4 | 18.3 | 20 | 23.3 | 17.1 | 65.5 |
| PHOS7 | 332 | 58 | 390 | 0.47 | 19.04 | 4.88 | 1.41 | 31.64 | 5.5 | 17.4 | 20.3 | 7 | 24 | 5.3 | 77.3 |
| PHOS8 | 334 | 24.5 | 359 | 0.54 | 9.91 | 6.98 | 0.89 | 31.64 | 3.19 | 10.1 | 10.3 | 5 | 23.5 | 3.7 | 86.2 |

*Total weight of slag sample collected:
^{$}Total weight of final slag and slag samples;
^{#}P remaining in the slag from the mass balance;
^{‡}P remaining in the slag based on the change of the P₂O₅/CaO ratio

Low concentration of phosphorus in the slag was achieved, with good phosphorus recoveries. All the experiments showed that the removal of P followed first order behaviour, i.e., the behaviour was of the form:

Cₜ=C₀·e^{bt}, where C₀ is the phosphorus concentration at t=0, and b is the exponential term and is usually negative in value. The greater the magnitude of b, the faster the rate.

FIG. 1 shows the change of phosphorus content with time for the medium phosphorus sample, smelted without fluxing. Low P₂O₅ content was obtained. FIG. 2 shows that at 1500° C., the reduction rate increased as the CaO/SiO₂ ratio in the slag increased.

The initial tests were at temperatures of 1400° C., with the expected liquidus temperatures of the slag to be around 100° C. lower. The findings from this test work were:
The non-optimised rate of carbothermic reduction at 1400° C. was slow, but can be enhanced by using lump coal, char or biomass.
Increasing temperature to 1500° C. increased the rate significantly. Phosphorus concentrations below 2% in the slag were achievable.
The lower the iron content of the feed, the higher the phosphorus recovery to the gas phase, without needing to recover phosphorus from the ferro-phosphorus.
Iron oxide was reduced from the slag to form a Fe—P alloy containing 24% P and C<0.08%.
The reduction of both P₂O₅ and Fe₂O₅ exhibited first order rate law behaviour.
The reduction rate of P and Fe increased as the slag basicity increased.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A process for recovering phosphorus from phosphoritic materials, the process comprising the steps of:
providing a furnace comprising a slag bath and a headspace above the slag bath, wherein the furnace is configured to facilitate submerged injection of a fluid into the slag bath, the fluid comprising a mixture of combustion agents to produce reducing conditions in the slag bath and post-combustion oxidising conditions in the headspace;
smelting a mixture of a phosphoritic material and a carbonaceous material in the furnace to produce a molten slag in the slag bath and phosphorus vapour in the headspace, wherein the post-combustion oxidising conditions in the headspace favours retention of ferrous oxides in the molten slag to minimise deportment of phosphorus to a ferro-phosphorus alloy;
oxidising the phosphorus vapour in the headspace to produce phosphorus pentoxide; and,
passing the phosphorus pentoxide from the headspace to a reactor to recover a phosphoric acid solution.

2. The process according to claim 1, wherein the mixture of a phosphoritic material and a carbonaceous material further comprises a flux.

3. The process according to claim 2, wherein the flux may be present in the mixture in an amount to obtain and maintain the molten slag at a liquidus temperature of 1400° C. or less.

4. The process according to claim 2, wherein the flux may be present in the mixture to provide Al₂O₃ in a range of 10 to 20% in the molten slag and a CaO:SiO₂ ratio between 1 and 0.25 in the molten slag.

5. The process according to claim 1, wherein the smelting step comprises:
a) feeding the phosphoritic material to the furnace to produce a molten slag having a high P content and,
b) reducing the P content in said molten slag to produce phosphorus vapour in the headspace of the furnace.

6. The process according to claim 5, wherein step b) comprises ceasing step a) and feeding the carbonaceous material to the furnace under operating conditions suitable for reducing the P content in said molten slag to <1%.

7. The process according to claim 1, wherein the carbonaceous material has a particle size less than 0.5 mm.

8. The process according to claim 7, wherein the carbonaceous material has a particle size P₈₅<75 μm.

9. The process according to claim 1, wherein smelting said mixture comprises maintaining the molten slag at a temperature of about 100° C. above a liquidus thereof.

10. The process according to claim 1, wherein the molten slag is at a temperature from 1300° C. to 1500° C.

11. The process according to claim 10, wherein the molten slag is at a temperature of from 1340° C. to 1450° C.

12. The process according to claim 9, wherein maintaining the molten slag at about 100° C. above the liquidus thereof comprises heating and agitating the molten slag by injecting said fluid therein.

13. The process according to claim 1, wherein the combustion agents comprise an oxygen-containing gas and a combustible fuel.

14. The process according to claim 1, wherein the fluid comprises a homogeneous mixture of an oxygen-containing gas and a hydrocarbon gas.

15. The process according to claim 1, wherein the fluid comprises a heterogeneous mixture of an oxygen-containing gas and the carbonaceous material.

16. The process according to claim 1, wherein the combustion agents are injected into the molten slag at a flow velocity of from 30 to 70 m/s at STP.

17. The process according to claim 1, wherein injecting the combustion agents into the molten slag ejects molten slag droplets into the headspace, wherein said droplets are heated by oxidation of phosphorus vapour to phosphorus pentoxide, thereby heating the molten slag when said droplets fall under the influence of gravity into the molten slag.

18. The process according to claim 17, wherein the molten slag droplets are oxidised in the headspace, thereby favouring retention of ferrous oxides in the molten slag to minimise deportment of phosphorus to a ferro-phosphorus alloy.

19. The process according to claim 1, wherein oxidising the phosphorus vapour comprises providing an oxygen-containing gas in the headspace of said furnace to react with the phosphorus vapour therein.

20. The process according to claim 1, wherein prior to passing the phosphorus pentoxide to the reactor, the process further comprises recovering thermal energy from the phosphorus pentoxide.

21. The process according to claim 20, wherein the recovered thermal energy is utilised for drying and/or heating feed materials for said furnace, power generation, and/or heating fluid streams.

22. The process according to claim 1, further comprising the step of tapping the molten slag from said furnace.

23. The process according to claim 1, wherein the molten slag comprises less than 5 wt % ferro-phosphorus alloy.

24. The process according to claim 1, wherein the molten slag comprises 1 wt % or less phosphorus.

25. The process according to claim 1, wherein the ferro-phosphorus alloy further comprises one or more metals other than iron.

26. The process according to claim 25, wherein the ferro-phosphorus alloy undergoes further processing to recover the one or more metals therein.

27. The process according to claim 1, wherein the furnace comprises a top submerged lance furnace.

28. The process according to claim 1, wherein the furnace comprises a fuming furnace.
